(19) United States
(12) Patent Application Publication
(10) Pub. No.: US 2015/0220946 A1
(43) Pub. Date: Aug. 6, 2015

(54) System and Method of Trend Identification

(71) Applicant: Verint Systems Ltd., Herzilya Pituach (IL)

(72) Inventors: Yair Horesh, Kfar-Saba (IL); Roni Romano, Even Yehuda (IL)

(21) Appl. No.: 14/610,232

(22) Filed: Jan. 30, 2015

Related U.S. Application Data
(60) Provisional application No. 61/934,311, filed on Jan. 31, 2014.

(51) Int. Cl. G06Q 30/02

(52) U.S. Cl. CPC G06Q 30/0202

(57) ABSTRACT

Improved systems and method as disclosed herein, provide automated analysis tools for more refined trend analysis and evaluation of identified trends. Communication data may be recognized as either audio or textual data which may be processed and analyzed in real-time (as in the case of streaming audio data) or processed at a time apart from the acquisition of the communication data. If the communication data is audio data, then the audio data, may undergo a transcription, which may employ the exemplary technique of large vocabulary continuous speech recognition (LVCSR) or other known speech-to-text algorithms or techniques. Alternatively, the communication data may already be in the form of a transcription or the communication data may have originated as textual data, exemplarily the communication data is from an internet web chat, email, text message, or social media.

The present disclosure is related to the field of automated data analysis. More specifically, the present disclosure is related to the identification of trends in communication data.

### BACKGROUND

Communication data, exemplarily interpersonal communication data can be recorded or streamed for real-time or later analysis. In a merely exemplary embodiment as used in the present disclosure, the communication data is exemplarily data of interpersonal communication, and more specifically communication data of a customer service interaction. In such setting wherein customer service interaction communication data is acquired, large amounts of communication data can be acquired daily, and therefore automated analysis tools are required in order to be able to practically analyze such data on an ongoing basis.

One such technique for automated analysis is the identification of trends within the communication data. Current approaches will identify occurrences of specific words in the communication data and calculate differences with which those words occur in the communication data versus a stored reference corpus of historical communication data or against previously calculated historical averages of word occurrences. These techniques generally rely on heuristics to evaluate whether a word frequency calculated from the communication data is within or outside of expected norms. Such systems and methods are also difficult to implement as differences in the historical averages or a set of communication data used to arrive at the historical averages can impact the trend result and further such results are often insensitive to periodically recurring or slow developing trends.

### SUMMARY

Improved systems and method as disclosed herein, provide automated analysis tools for more refined trend analysis and evaluation of identified trends.

One aspect of the disclosure discloses a method of automated trend identification, that can include: receiving communication data; receiving at least one modularity selection, the modularity selection defining a plurality of features; identifying instances of the features in the communication data; receiving at least one report selection; producing a statistical measure of the identified instances of the features; evaluating the statistical measure; and identifying a trend of interest from the evaluation of the statistical measure, wherein the trend of interest comprises a report selection and a feature. Moreover, the instances of the features can be identified within a time interval of the communication data. A statistical model can be selected based upon the received at least one report selection, and the statistical model can be used to produce the statistical measure. The identified instances of features in the communication data can be normalized to produce a normalized identified instances, and the statistical measure can be of a non normalized identified instances. Furthermore, the normalization can comprises a t-test.

The trends of interest can comprise a trend within the top five of all of the identified trends for that feature or that report selection in the received communication data. The report selection can comprise one of a general trend report, a correlation report, an enriched week-day report, an enriched week report, an enriched month reports, a daily spike reports, and a weekly and monthly periodic pattern report. The modularity selection can comprise a set list of specific occurrences of relations, script clusters, and micro patterns that are used with a selection of a feature. Finally, a user may find or select the features to be used in the trend identification.

Another aspect of the disclosure discloses a computing system for automated trend identification, the system comprising a processing system comprising computer-executable instructions stored on memory that can be executed by a processor in order to receive communication data; receive at least one modularity selection, the modularity selection defining a plurality of features; identify instances of the features in the communication data; receive at least one report selection; produce a statistical measure of the identified instances of the features; evaluate the statistical measure; and identify a trend of interest from the evaluation of the statistical measure, wherein the trend of interest comprises a report selection and a feature. Furthermore, the features can be identified within a received time interval of the communication data. A statistical model can be selected based upon the received at least one report selection, and wherein the statistical model can be used to produce the statistical measure. The identified instances of features in the communication data can be normalized to produce a normalized identified instances, wherein the statistical measure is of a non normalized identified instances. The normalization can comprise a t-test. The trends of interest can comprise a trend within the top five of all of the identified trends for that feature or that report selection in the received communication data. The report selection can comprise one of a general trend report, a correlation report, an enriched week-day report, an enriched week report, an enriched month reports, a daily spike reports, and a weekly and monthly periodic pattern report. The modularity selection can comprise a set list of specific occurrences of relations, script clusters, and micro patterns that are used with a selection of a feature. Finally, a user may find or select the features to be used in the trend identification.

In another aspect of the disclosure, a non-transitory computer readable medium is disclosed, comprising computer-executable instructions that when executed by a processor of a computing device perform a method. The method can perform the steps of receiving communication data; receiving at least one modularity selection, the modularity selection defining a plurality of features; identifying instances of the features in the communication data;

receiving at least one report selection; producing a statistical measure of the identified instances of the features; evaluating the statistical measure; and identifying a trend of interest from the evaluation of the statistical measure, wherein the trend of interest comprises a report selection and a feature.

### BRIEF DESCRIPTION OF THE DRAWINGS

FIG. 1 is a flow chart that depicts an exemplary embodiment of a method of automated trend analysis.

FIG. 2 is a system diagram of an exemplary embodiment of a system for automated trend analysis.

FIGS. 3A-L are exemplary embodiments of trend graphs produced by systems and methods as disclosed herein.

### DETAILED DISCLOSURE

In the field of automated analysis of communication data, an exemplary embodiment as used herein includes interpersonal communication data, which may exemplarily be communication data of a customer service interaction between a customer service agent and a customer. In embodiments, communication data may be recognized as either audio or textual data which may be processed and analyzed in real-time (as in the case of streaming audio data) or processed at a time apart from the acquisition of the communication data. In some embodiments, it is recognized if the communication data is audio data, then the audio data, may undergo a transcription, which may employ the exemplary technique of large vocabulary continuous speech recognition (LVCSR) or other known speech-to-text algorithms or techniques. Alternatively, the communication data may already be in the form of a transcription or the communication data may have originated as textual data, exemplarily the communication data is from an internet web chat, email, text message, or social media.

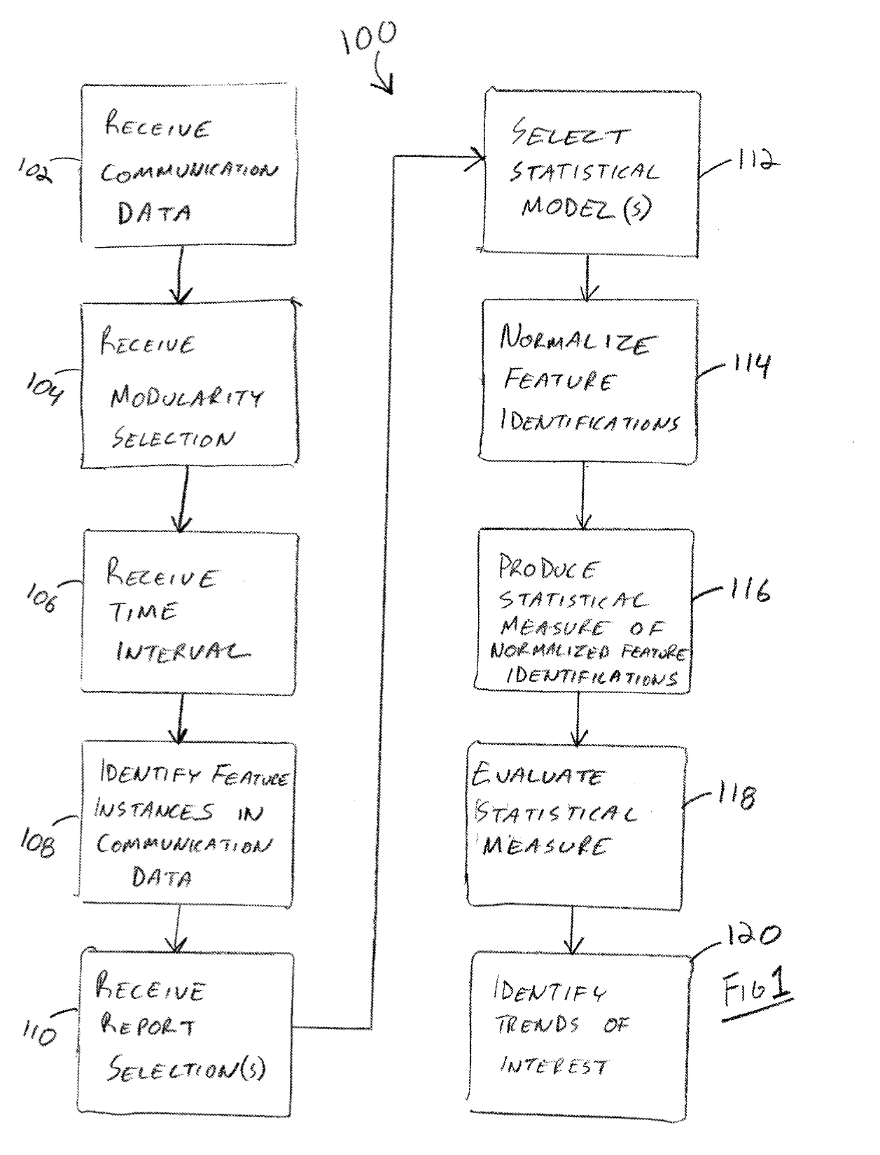

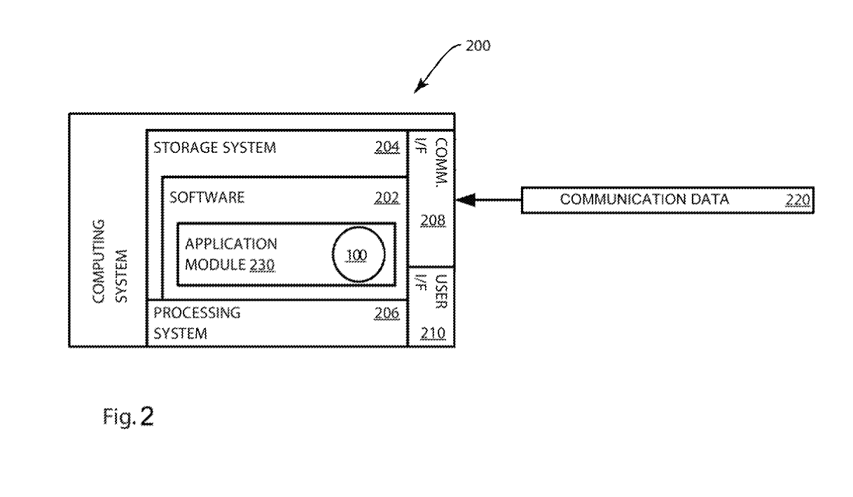

FIG. 1 is a flow chart that depicts an exemplary embodiment of a method 100 of automated trend identification. FIG. 2 is a system diagram of an exemplary embodiment of a system 200 for automated trend identification. The system 200 is generally a computing system that includes a processing system 206, storage system 204, software 202, communication interface 208 and a user interface 210. The processing system 206 loads and executes software 202 from the storage system 204, including a software module 230. When executed by the computing system 200, software module 230 directs the processing system 206 to operate as described in herein in further detail in accordance with the method 100.

Although the computing system 200 as depicted in FIG. 2 includes one software module in the present example, it should be understood that one or more modules could provide the same operation. Similarly, while description as provided herein refers to a computing system 200 and a processing system 206, it is to be recognized that implementations of such systems can be performed using one or more processors, which may be communicatively connected, and such implementations are considered to be within the scope of the description.

The processing system 206 can include a microprocessor and other circuitry that retrieves and executes software 202 from storage system 204. Processing system 206 can be implemented within a single processing device but can also be distributed across multiple processing devices or sub-systems that cooperate in existing program instructions. Examples of processing system 206 include general purpose central processing units, application specific processors, and logic devices, as well as any other type of processing device, combinations of processing devices, or variations thereof.

The storage system 204 can comprise any storage media readable by processing system 206, and capable of storing software 202. The storage system 204 can include volatile and non-volatile, removable and non-removable media implemented in any method or technology for storage of information, such as computer readable instructions, data structures, program modules, or other data. Storage system 204 can be implemented as a single storage device but may also be implemented across multiple storage devices or sub-systems. Storage system 204 can further include additional elements, such a controller capable, of communicating with the processing system 206.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to storage the desired information and that may be accessed by an instruction execution system, as well as any combination or variation thereof, or any other type of storage medium. In some implementations, the storage media can be a non-transitory storage media. In some implementations, at least a portion of the storage media may be transitory. It should be understood that in no case is the storage media a propagated signal.

User interface 210 can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a video display or graphical display can display an interface further associated with embodiments of the system and method as disclosed herein. Speakers, printers, haptic devices and other types of output devices may also be included in the user interface 210.

As described in further detail herein, the computing system 200 receives communication data 220. The communication data 220 may exemplarily be a text file and may exemplarily be a transcription of a conversation or interaction which may exemplarily be between two speakers, although the transcription may be of any of a variety of other interactions, including multiple speakers, a single speaker, or an automated or recorded message. In a further exemplary embodiment, the communication data is of a customer service interaction between a customer and a customer service agent. In another embodiment, the communication data 220 is text data from web chat, email, or social media.

In still further embodiments, the communication data 220 may be audio data that can be transcribed by the computing system 200. In such embodiments, the processing system 206 may be capable of performing a transcription of audio data, exemplarily by applying large vocabulary continuous speech recognition (LVCSR) speech-to-text algorithms. The audio data may exemplarily be a .WAV file, but may also be other types of audio files, exemplarily in a pulse code modulation (PCM) format and an example may include linear pulse code modulated (LPCM) audio file. Furthermore, the audio file may exemplary be a mono audio file; however, it is recognized that in embodiments the audio file may alternatively be a stereo audio file. In still further embodiments, the audio file may be streaming audio data received in real time or near-real time by the computing system 200.

FIG. 1 is a flow chart that depicts an exemplary embodiment of a method 100 of automated identification of trends. The method 100 begins at 102 by receiving communication data as described above, the communication data may exemplarily be audio data or textual data, and in exemplary embodiments may be communication data of a customer service interaction.

Next, at 104 a modularity selection is received. The modularity selection may include the selecting of one or more features which will be investigated for trends in the received communication data. Non-limiting example of the features include relations, group clusters, and micro patterns. Relations are defined binary directed relationships between terms and entity/sub-classes or sub classes to entities within an ontology which is a formal representation of a set of concepts and the relationships between these concepts. In a non-limiting example, the term “pay” is defined under the entity “action” and the term “bill” is defined in an entity “document.” Scripts are strings of multiple terms that are standardized in order to convey specific information. Micro patterns are flexible templates that capture a relatively short concept with a relatively well-defined format. Micro patterns are similar to scripts, although typically are shorter in duration, as micro patterns are concepts that often occur in an interpersonal interaction. Often, micro patterns include a number string or other similar strings of data that represent a concept as a whole. In non-limiting example, micro patterns may be a pure number string but may also represent a time period, a price, a credit card number, an amount of computer memory, a processing speed, a telephone number, a percent, a daily time, a date, a year, an account number, or an internet speed.

The received modularity selection may be a selection of one or more of these features. In one exemplary embodiment, a set list of specific occurrences of relations, script clusters, and micro patterns may be used with the selection of a particular feature. In another exemplary embodiment, a user may find or otherwise select the specific features (e.g. specific relations, script clusters, and micro patters) to be used in the trend identification. It is to be recognized that other types of features may be available in the modularity selection, exemplarily abstract relation or term.

Next, at 106 a time interval is received. In embodiments, a particular time interval of the received communication data may be developed or more specific analysis of a refined time interval of the received communication data, rather than the communication data as a whole.

At 108 feature instances are identified in the communication data, or in the received time interval of the communication data. This identification may exemplarily be performed by comparing the specific features as received in the modularity selection to the communication data in order to identify a count of occurrences of the features in the communication data. Such count may be identified in some temporal basis, exemplarily daily, although other temporal intervals as recognized by a person of ordinary skill in the art.

At 110 a selection of one or more reports is received. Embodiments of the systems and methods as disclosed herein increase trend identification accuracy by specifically tailoring the methods and algorithms as described in further detail herein to a specific report or reports to be used. In exemplary embodiment, the reports may each represent different types of trends that could be identified.

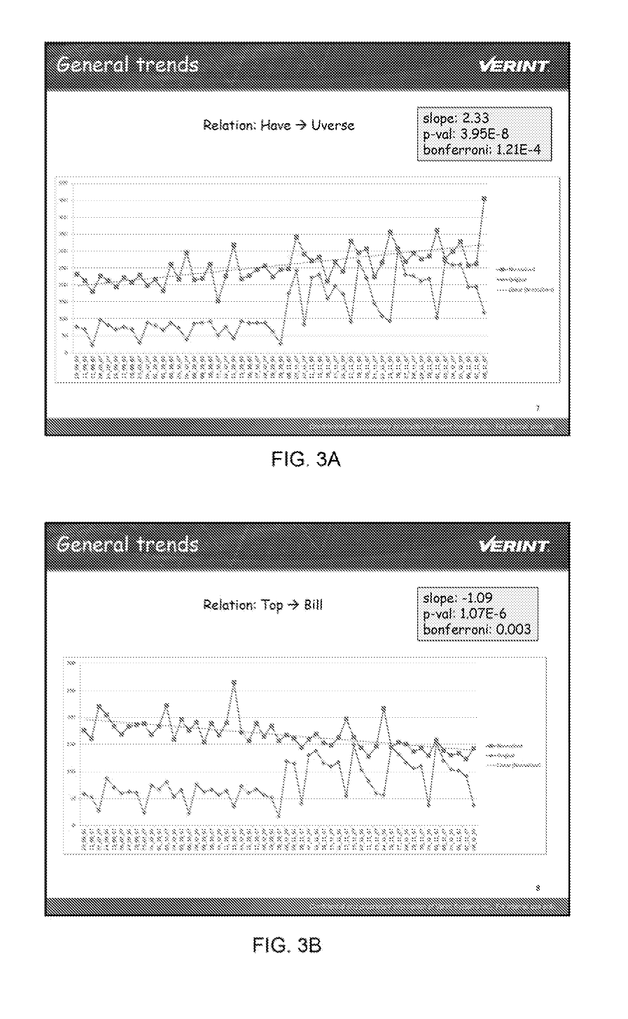

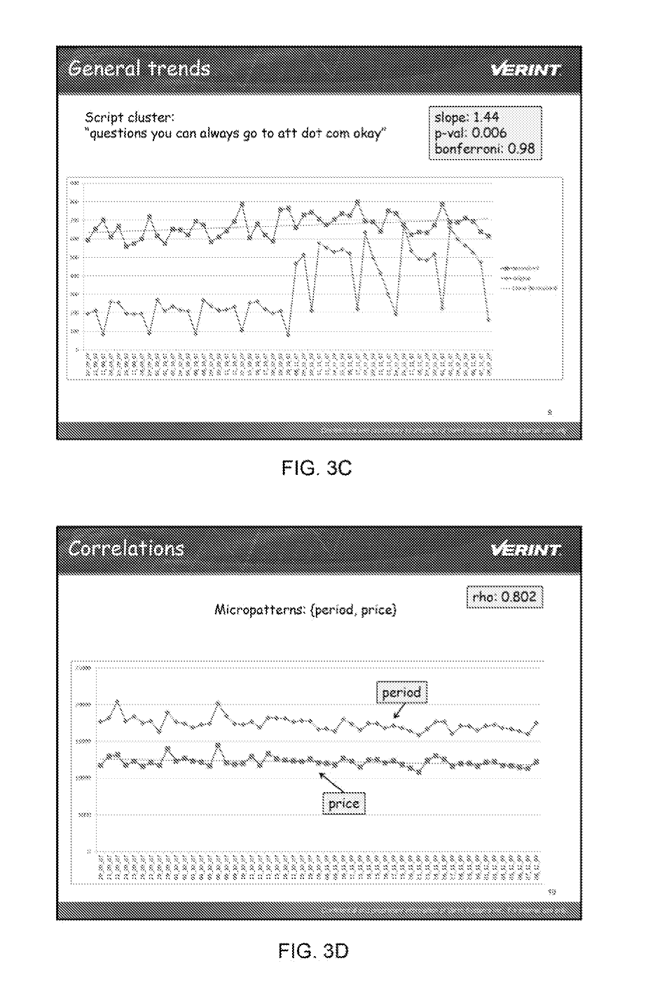

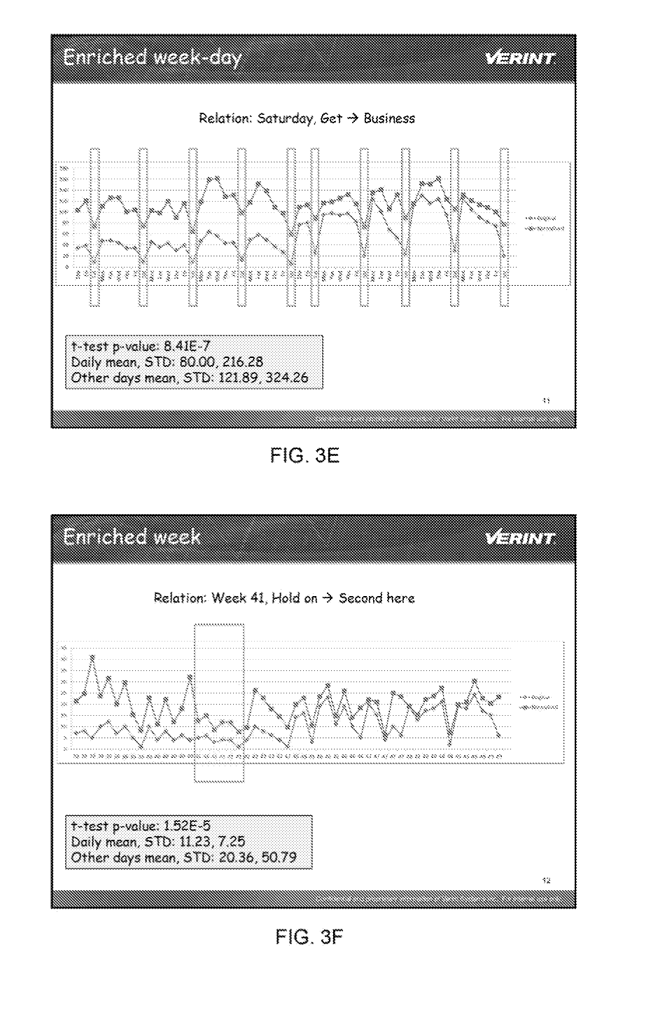

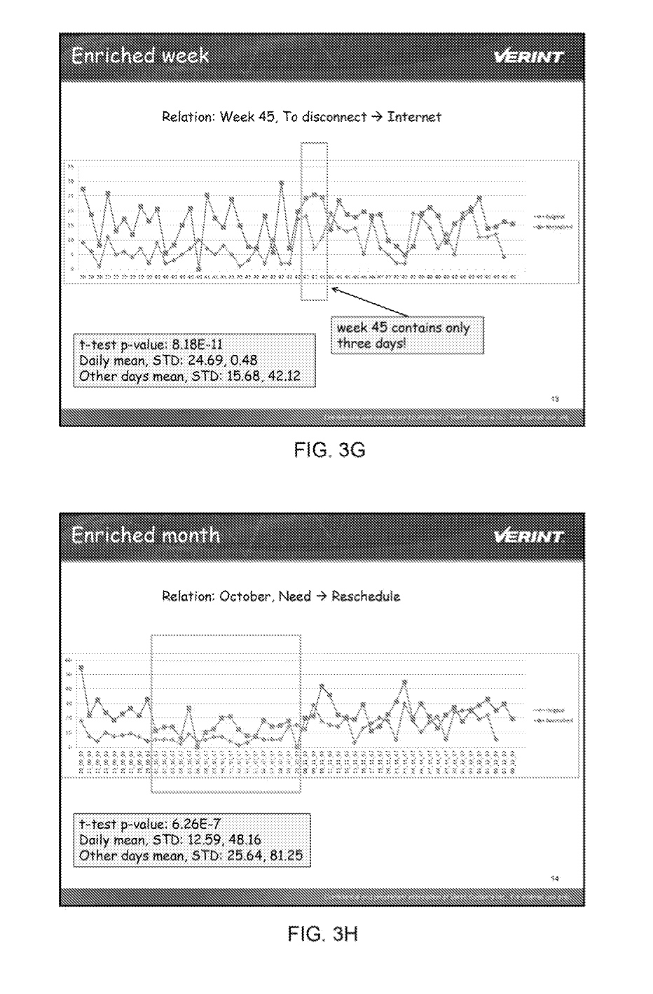

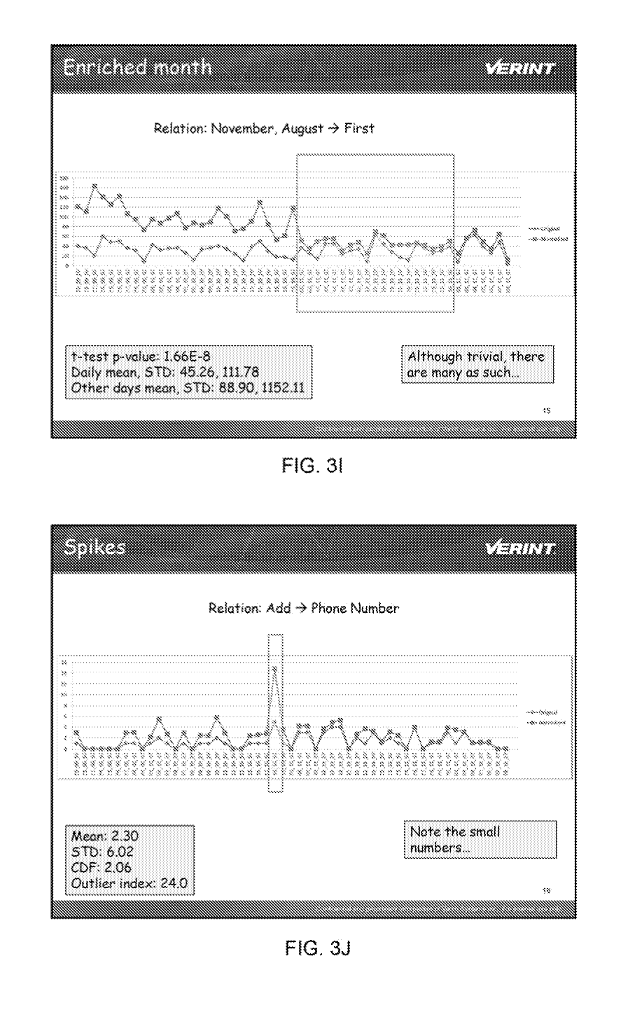

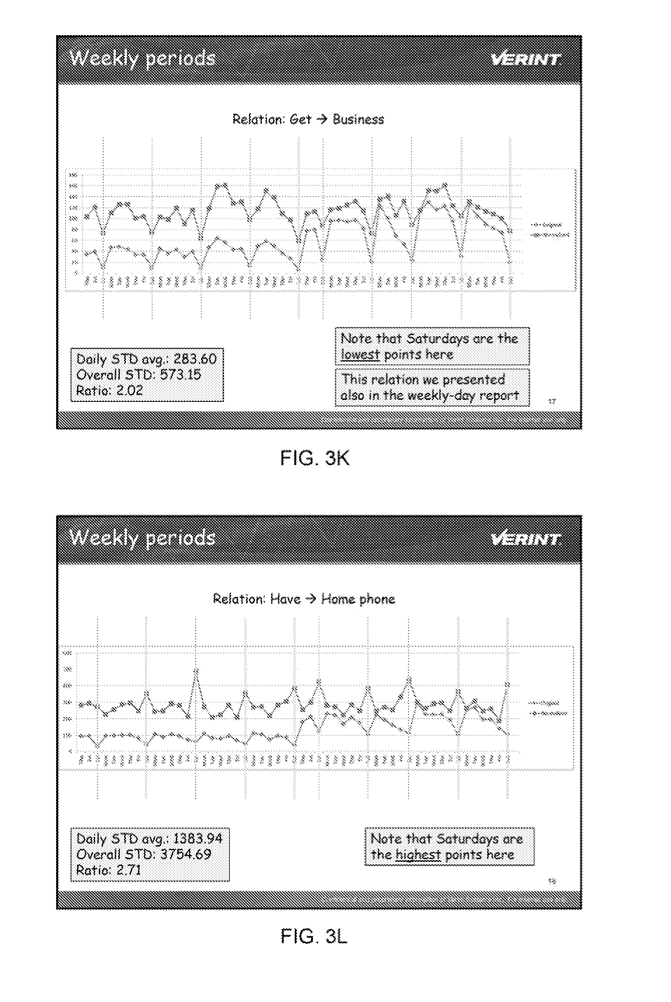

A number of exemplary embodiments of reports will be described herein, although a person of ordinary skill in the art will recognize additional reports that may be created or implemented in accordance with the disclosure found herein. A general trends report is designed to identify the most significant trends for the received time interval. FIGS. 3A-3C depict exemplary embodiments as described herein of general trend report. Correlation reports identify significant correlations (and anti-correlation) between two features. FIG. 3D depicts an exemplary embodiment of a correlation report. In which week-day reports identify features that are significantly over or under expressed during a specific week day (e.g. Friday), compared to the other week days. FIG. 3E depicts an exemplary embodiment of an enriched week-day report. In which week report identifies features that are significantly over or under expressed during a specific week (e.g. the 36^{th} week of the year) compared to the other weeks. FIGS. 3F and 3G depict exemplary embodiments of enriched week reports. Enriched month reports identify features that are significantly over or under expressed during a specific month (e.g. October) compared to the other months. FIG. 3H and 3I exemplarily depicts embodiments of enriched month reports. Daily spike reports identify the most significant daily spikes in a feature on the top frame given. FIG. 3J depicts and exemplary embodiment of a theory spike report. Weekly periodic pattern reports identify features that significantly behave in a weekly periodic cycle. A monthly periodic pattern reports identify features that significantly behave in a monthly periodic cycle. FIGS. 3K and 3L depict exemplary embodiments of weekly periodic reports.

In exemplary embodiments the report selections may be received as a default selection of all of the reports in order to provide a robust identification of trends. Alternatively, it is to be recognized that the report selections received at 110 may be a subset of all of the available reports, and different reports may be selected for different features received in the modularity selection at 104.

At 112 statistical models used to evaluate the identified trends as described in further detail herein, are selected. In embodiments, the selection of the statistical models at 112 is based upon the selected reports. In exemplary embodiments, each of the available reports is associated with a particular statistical model is used to evaluate the analysis of that report. In an exemplary embodiment, general trend reports are associated with a linear regression and significance tests. Correlation reports are associated with Pearson Correlations Test. Enriched week-day reports are associated with a t-test. Enriched week reports are associated with a t-test. Enriched month reports are associated with a t-test. Daily spike reports are associated with a Chauvenet's Criterion. Weekly and monthly periodic pattern reports are associated with standard deviation ratios.

At 114 the feature identifications from 108 are normalized in order to normalize the identified feature instances with the amount of received communication data. In some embodiments, the selected statistical model may be applied in order to normalize the feature identifications at 114. In another non-limiting example a t-test may be used for this normalization.

At 116 a statistical measure of the normalized feature identifications is produced by applying the selected statistical model to the normalized feature identifications or the raw feature identification counts. The exemplary report depicted at FIGS. 3A-3L include the raw feature identification counts, normalized featured identification counts, and the selected statistical measure in accordance with 116. At 118 the results of each of the trend reports are individually evaluated based upon the statistical measure produced at 116. This evaluation may include the comparison of the statistical measure value to a predetermined threshold indicative of a trend of interest of importance or other form of research significance. In still further embodiments, the threshold may be model specific, wherein each of the statistical models selected at 112 has a different predetermined threshold used to evaluate if an identified trend is of interest or significance.

At 120, based upon the evaluation of the statistical measure at 118, trends of interest are identified. In exemplary embodiments, the trends of interest may be those identified trends from reports wherein the statistical measure is above a predetermined threshold. In other embodiments, the trends of interest are identified when a trend is within the top 5 of all of the identified trends for that feature or that report in the received communication data. In still further embodiments, the statistical measures may be compared across reports or across features in order to identify the most significant identified trends within the communication data.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of automated trend identification, the method comprising:
receiving communication data;
receiving at least one modularity selection, the modularity selection defining a plurality of features;
identifying instances of the features in the communication data;
receiving at least one report selection;
producing a statistical measure of the identified instances of the features;
evaluating the statistical measure; and
identifying a trend of interest from the evaluation of the statistical measure, wherein the trend of interest comprises a report selection and a feature.

2. The method of claim 1, further comprising:
receiving a time interval, wherein the instances of the features are identified within the time interval of the communication data.

3. The method of claim 1, further comprising selecting a statistical model based upon the received at least one report selection, and wherein the statistical model is used to produce the statistical measure.

4. The method of claim 3, further comprising normalizing the identified instances of features in the communication data to produce a normalized identified instances, wherein the statistical measure is of a non normalized identified instances.

5. The method of claim 4, wherein the normalization comprises a t-test.

6. The method of claim 1, wherein the trends of interest comprises a trend within the top five of all of the identified trends for that feature or that report selection in the received communication data.

7. The method of claim 1, wherein the report selection can comprise one of a general trend report, a correlation report, an enriched week-day report, an enriched week report, an enriched month report, a daily spike report, and a weekly and monthly periodic pattern report.

8. The method of claim 1, wherein the modularity selection comprises a set list of specific occurrences of relations, script clusters, and micro patterns that are used with a selection of a feature.

9. The method of claim 1, wherein a user may find or select the features to be used in the trend identification.

10. A computing system for automated trend identification, the system comprising a processing system comprising computer-executable instructions stored on memory that can be executed by a processor in order to:
receive communication data;
receive at least one modularity selection, the modularity selection defining a plurality of features;
identify instances of the features in the communication data;
receive at least one report selection;
produce a statistical measure of the identified instances of the features;
evaluate the statistical measure; and
identify a trend of interest from the evaluation of the statistical measure, wherein the trend of interest comprises a report selection and a feature.

11. The system of claim 10, further comprising:
receiving a time interval, wherein the instances of the features are identified within the time interval of the communication data.

12. The system of claim 10, further comprising selecting a statistical model based upon the received at least one report selection, and wherein the statistical model is used to produce the statistical measure.

13. The system of claim 12, further comprising normalizing the identified instances of features in the communication data to produce a normalized identified instances, wherein the statistical measure is of a non normalized identified instances.

14. The system of claim 13, wherein the normalization comprises a t-test.

15. The system of claim 10, wherein the trends of interest comprises a trend within the top five of all of the identified trends for that feature or that report selection in the received communication data.

16. The system of claim 10, wherein the report selection can comprise one of a general trend report, a correlation report, an enriched week-day report, an enriched week report, an enriched month report, a daily spike report, and a weekly and monthly periodic pattern report.

17. The system of claim 10, wherein the modularity selection comprises a set list of specific occurrences of relations, script clusters, and micro patterns that are used with a selection of a feature.

18. The system of claim 10, wherein a user may find or select the features to be used in the trend identification.

19. A non-transitory computer readable medium comprising computer-executable instructions that when executed by a processor of a computing device perform a method, comprising:
receiving communication data;
receiving at least one modularity selection, the modularity selection defining a plurality of features;
identifying instances of the features in the communication data;
receiving at least one report selection;
producing a statistical measure of the identified instances of the features;
evaluating the statistical measure; and
identifying a trend of interest from the evaluation of the statistical measure, wherein the trend of interest comprises a report selection and a feature.
